(19) United States
(12) Patent Application Publication
(10) Pub. No.: US 2007/0052133 A1
(43) Pub. Date: Mar. 8, 2007

(54) Methods for fabricating sub-resolution line space patterns

(76) Inventors: Michael Gostkowski, Austin, TX (US); Shu Ikeda, Austin, TX (US); Jeff Wetzel, Austin, TX (US)

Correspondence Address: FULBRIGHT & JAWORSKI L.L.P., 600 CONGRESS AVE., SUITE 2400, AUSTIN, TX, 78701, US

(21) Appl. No.: 11/220,898

(22) Filed: Sep. 7, 2005

(51) Int. Cl. B29C 35/08; B29C 69/00

(52) U.S. Cl. 264/241; 264/488

(57) ABSTRACT

Methods for fabricating sub-resolution line space patterns are disclosed. In one embodiment, a method includes steps for fabricating a half-pitch pattern having equal line to space dimension. In other embodiments, method includes steps for fabricating a quarter-pitch pattern having equal line to space dimension. The disclosure also provides steps for fabricating small trench structures with spacers

### BACKGROUND OF THE INVENTION

1. Field of the Invention

The present invention relates generally to semiconductor fabrication, and more particularly to a method for fabricating sub-lithography resolution geometries with defined pitches.

2. Description of Related Art

In the production of semiconductor and nano devices, there are a number of lithographic exposure steps where an image is projected onto a photosensitive material coating on a wafer. Typically, the image pattern can be either a positive or negative mask image that is projected onto the coated wafer using an optical lithography system. The optical lithography system emits radiation at a wavelength λ, which chemically changes the exposed areas of the coating, usually by polymerizing the coating exposed to the radiation. Depending on the solvent used, the unpolymerized areas are removed, and the desired pattern image remains.

However, as technology advances and device sizes become smaller, the need to resolve smaller image features becomes more difficult, especially since the diffraction limits of visible light wavelengths have been reached. In order to continue printing these features with high resolution and contrast, shorter wavelength radiation is needed. Typical optical lithography systems, such as steppers, may use radiation at wavelengths such as 365 nm, 248 mm, 193 nm, 157 nm, and 126 nm. However, only 193 nm steppers are commercially available for volume manufacturing, while steppers using 157 nm and 126 nm wavelengths are still being developed. Advanced non-optical lithography systems with shorter wavelengths such as extreme ultraviolet or soft x-rays are now being actively researched for printing complex patterns in submicron ranges. However, the problem of diffraction limited optics remains, and the drive to using shorter wavelengths provides only limited results.

In addition to shorter wavelength radiation, there are several techniques available for high resolution and contrast optical lithography. One technique developed uses phase-shifting masks to increase the resolution and contrast of optical lithography. Light rays transmitted through adjacent apertures of the mask follow different phases. However, phase-shifting masks are costly and difficult to manufacture because the phase structure must be closely related to specific geometries of the mask pattern. Moreover, as microcircuit pitches shrink in size, mask making techniques do not necessarily keep pace.

Another technique used is referred to as engineered illumination to help print smaller and smaller features of semiconductor microcircuits. This technique relies upon the use of various patterns of illumination including annular and quadrapole illumination and off-axis illumination. However, these require that the illuminator be extensively modified. Additionally, these methods and assist features are time consuming, expensive, and less efficient.

Other techniques involve advanced non-optical lithography systems such as extreme ultraviolet (EUV) lithography and e-beam (SCALPEL) lithography. However, these systems are currently being developed and are also cost-prohibitive.

Any shortcoming mentioned above is not intended to be exhaustive, but rather is among many that tends to impair the effectiveness of previously known techniques for fabricating a sub-resolution line to space patterns; however, shortcomings mentioned here are sufficient to demonstrate that the methodologies appearing in the art have not been satisfactory and that a significant need exists for the techniques described and claimed in this disclosure.

### SUMMARY OF THE INVENTION

Other features and associated advantages will become apparent with reference to the following detailed description of specific embodiments in connection with the accompanying drawings.

In one respect, a method for fabricating a structure including a line and space having substantially equal dimension is disclosed. The method includes steps for depositing a first material on a substrate followed by the deposition of a second material on the first material. A photoresist layer may be deposited on the second material and patterned using a light source having a wavelength of λ. The second material may be etched and forms a plurality of structures having a dimension of less than λ. Next, a third material may be deposited on the etched second material. The third material may subsequently be etched, exposing a surface of the second material. The exposed portion may allow the second material to be removed, and the first material to be etched to form a structure including a line and space of substantially equal dimensions.

In one embodiment, the third material may be used as a mask to etch the first material to form a line and space structure having line and space dimensions of approximately λ/2. Alternatively, in other embodiments, a fourth material may be deposited after the step of removing the second material. The second and third material may subsequently be removed, and the fourth material may be used as a mask for the step of etching the first material. The resultant structure may include a line and space having a dimension of λ/4.

In other respects, a method for forming a structure comprising spaces having a dimension of d is disclosed. The method provides steps for depositing a first material on a substrate followed by the deposition of a second material on the first material. A photoresist layer may be deposited on the second material and patterned using a light source having a wavelength of λ. The second material may be etched and forms a plurality of structures having a dimension of less than λ.

Next, a third material may be deposited on the etched second material. The third material may subsequently be etched to expose a portion of the second material. A fourth material may be deposited on the second and third materials and the entire structure may be polished using a chemical mechanical polishing technique, exposing a portion of the second, third, and fourth materials. In some embodiments, the third material may be removed, and the remaining second and fourth material may be used as a mask during the step of etching the first material to form a trench structure having spaces of dimensions d.

In other embodiments, the second and fourth material may be removed and the third material may be used as a mask during the etching step of the first material. The resultant structure includes spaces having a dimension of λ/2.

Alternatively, in some embodiments, after the step or removing the second and fourth material, a fifth material may be deposited on the remaining first and third material. The fifth material may be etched to expose a portion of the third material. The third material may subsequently be removed, and the etched fifth material may be used as a mask during the step of etching the first material. The resultant structure includes spaces having a dimension of λ/4.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The figures are examples only. They do not limit the scope of the invention.

FIG. 1 is a half pitch pattern definition, in accordance with embodiments of this disclosure.

FIG. 2 is a flowchart of a method for fabricating a half pitch pattern definition, in accordance with embodiments of this disclosure.

FIG. 3 is a flowchart of a method for fabricating a half pitch pattern definition using a chemical mechanical polish technique, in accordance with embodiments of this disclosure.

FIG. 4 is a quarter pitch pattern definition, in accordance with embodiments of this disclosure.

FIGS. 5A and 5B is a flowchart of a method for fabricating a quarter pitch pattern definition, in accordance with embodiments of this disclosure.

FIGS. 6A and 6B is a flowchart of a method for fabricating a quarter pitch pattern definition using a chemical mechanical polish technique, in accordance with embodiments of this disclosure.

FIG. 7 is a small trench definition, in accordance with embodiments of this disclosure.

FIGS. 8A and 8B is a flowchart of a method for fabricating a small trench dimensions using a chemical mechanical polish technique, in accordance with embodiments of this disclosure.

### DESCRIPTION OF ILLUSTRATIVE EMBODIMENTS

The disclosure and the various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

The present disclosure provides fabrication techniques for space features of sub-lithography resolution geometries. These features may be created with well defined pitch by controlling the dimensions of a patterned sacrificial line and the deposition thickness of spacer materials. In some embodiments, half-pitch, quarter-pitch, and small space structures may be achieved. The present disclosure also provides use of a subordinate procedure with base fabrication processes. The procedure allows for an improved process control by integrating a chemical mechanical polish step.

Half-Pitch Pattern Formation

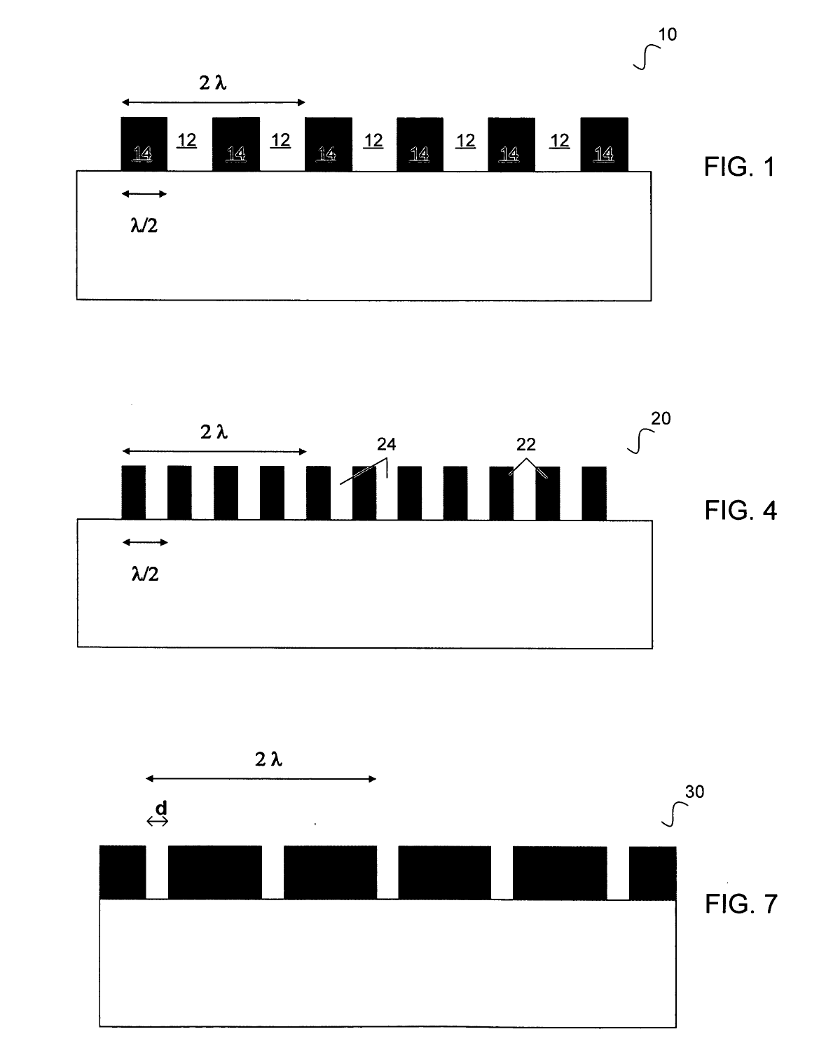

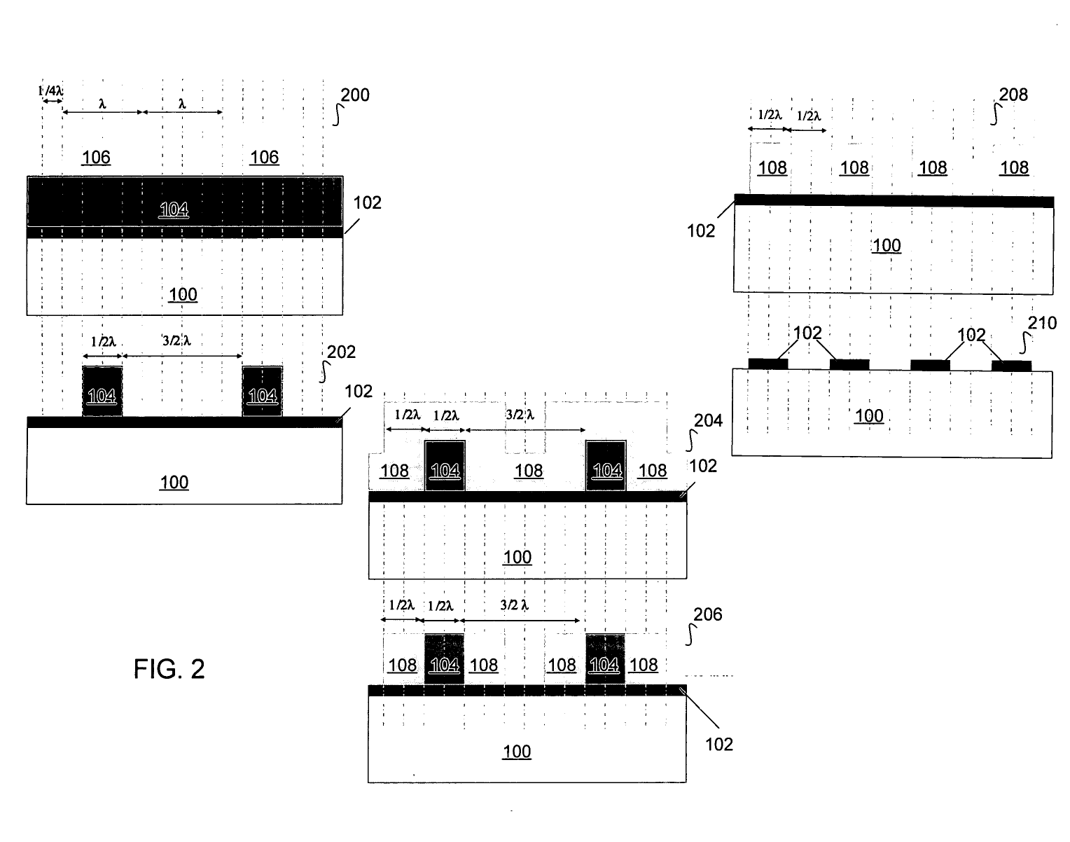

In one embodiment, a half-pitch pattern may be fabricated, as defined in FIG. 1. Structure 10 includes a substantially equal geometry line, where space 12 may be substantially equal to patterned material 14, e.g., the ratio between patterned material 14 and space 12 is approximately 1:1. Referring to FIG. 2, a method for creating structure 10 is shown. In step 200, first material 102, which may be used for a final pattern transfer, may be deposited onto substrate 100. Also in step 200, second material 104 may be deposited on first material 102. In one embodiment, a number of selections may be made for materials 102 and 104 depending upon the integration approach. Several of these combinations include for material 102 (SiO₂, Si, SiN) with similar materials selected for material 104 (SiO₂, Si, SiN). A non-limiting example of the types materials for first material 102, second material 104, and third material 108 is shown in Table 1. It is noted that other materials including, without limitation, metallic layers, insulation layers, silicon layers, and other films may be used.

TABLE 1
Examples of materials used in the fabrication for a 0.5 Lambda patterns
0.5 LAMBDA INTEGRATION

| Case/Layer | 102 | 104 | 108 | DEPOSITION METHODS |
|---|---|---|---|---|
| A | SiO2 | SiN | Si | LPCVD or PECVD or ALD or PVD |
| B | SiO2 | Si | SiN | LPCVD or PECVD or ALD or PVD |
| C | Si | SiO2 | SiN | LPCVD or PECVD or ALD or PVD |
| D | Si | SiN | SiO2 | LPCVD or PECVD or ALD or PVD |
| E | SiN | Si | SiO2 | LPCVD or PECVD or ALD or PVD |
| F | SiN | SiO2 | Si | LPCVD or PECVD or ALD or PVD |

Next, photoresist layer 106 may be deposited and aligned on second material 104 and may subsequently be patterned using techniques know in the art. In one embodiment, photoresist material 106 may be etched at approximately a 1:1 line-space dimension using techniques such as exposing the photoresist through a mask with an electromagnetic radiation source at some wavelength, λ. The electromagnetic radiation source includes, but is not limited to, ultraviolet light, infrared sources, and the like. Any portion of photoresist layer 106 that has been exposed to the light may be removed, resulting in a patterned photoresist layer. As shown in step 200, the space geometry may be patterned at a pitch of 2λ, where the pitch may be assumed to be near the resolution of the lithography tool used in pattern transfer.

In step 202, second material 104 may be etched using techniques known in the art. In one embodiment, the etching process may include controlling the photoresist critical dimension and trim etch process to etch second material 104 such that an approximate 0.5 λ line and a 10.5 λ space pattern occur.

Next, third material 108 may be deposited onto etched second material 104, as seen in step 204, where the deposition may be symmetric distribution of third material 108 around second material 204. The thickness of third material 108 may be controlled to be at approximately 0.5 λ. In one embodiment, third material 108 may be conformally deposited over the top of the resulting line and space of step 202.

In step 206, third material 108 may be etched using techniques known in the art. In one embodiment, the etching process may be selective to second material 104 such that a top surface of second material 104 is exposed. The etching step may result in individual, distinguish region of second material 104 and third material 108 with an open space each of 0.5 λ, as shown in step 206.

In step 208, second material 104 may be removed. In one embodiment, second material 104 may be removed using an etchant selective to both third material 108 and first material 102 may be used. Using third material 108 as an approximate 1:1 line-space mask, a half-pitch pattern (0.5 λ) may be transferred onto first material 102, as shown in step 210. In one embodiment, first material 102 may be etched using techniques known in the art. The resultant structure from step 208 is similar to structure 10 of FIG. 1.

In other embodiments, a half-pitch pattern formation may be fabricated using a chemical mechanical polishing (CMP) technique, in particular forming a line-space with a ratio of approximately 1:1. The CMP may improve the control of the patterned geometries.

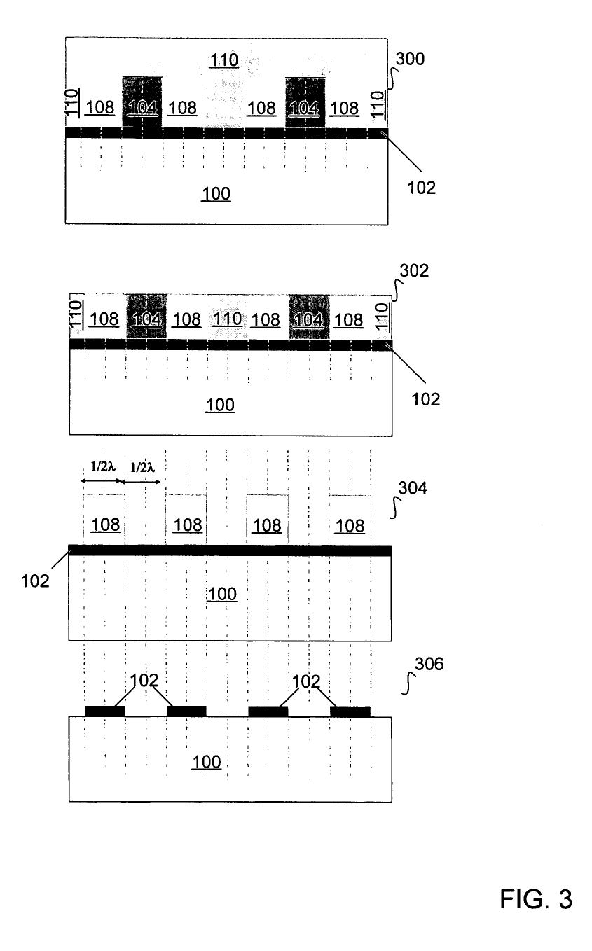

In one embodiment, steps similar to steps 200, 202, 204, and 206 may be performed. Next, referring to FIG. 3, fourth material 110 may be deposited on the resulting structure from step 206. In one embodiment, fourth material 110 may be the same material as second material 104. Referring to Table 2, some non-limiting examples are presented representing the types of materials that may be used to fabricate a 0.5 λ pitch.

TABLE 2
Examples of materials used in the fabrication for a 0.5 Lambda patterns
0.5 LAMBDA INTEGRATION

| Case/Layer | 102 | 104 | 108 | 110 |
|---|---|---|---|---|
| A | SiO2 | SiN | Si | SiN |
| B | SiO2 | Si | SiN | Si |
| C | Si | SiO2 | SiN | SiO2 |
| D | Si | SiN | SiO2 | SiN |
| E | SiN | Si | SiO2 | Si |
| F | SiN | SiO2 | Si | SiO2 |

A CMP technique may be used to remove a top portion of first and fourth material, exposing a top portion of third material 108, as seen in step 302. The CMP technique may allow second material 104 to be squared off, substantially alleviating any curvature in the top surface of second material 104 that may have resulted in step 206. This produces an approximate 1:1 line-space pattern with each region of material having a dimension of λ, as seen in step 302.

In step 304, second material 104 and fourth material 110 may be removed. In one embodiment, an etchant selective to third material 108 and first material 102 may be used to remove second and fourth material 104 and 110, respectively. Similar to step 210, step 306 uses third material 108 as a 1:1 mask and a half pitch pattern may be transferred onto substrate 100. In one embodiment, first material 102 may be etched using techniques known in the art. Alternatively, other techniques for removing a portion of first material 102 may be used. The resultant structure from step 306 is similar to structure 10 of FIG. 1.

Quarter-Pitch Pattern Formation

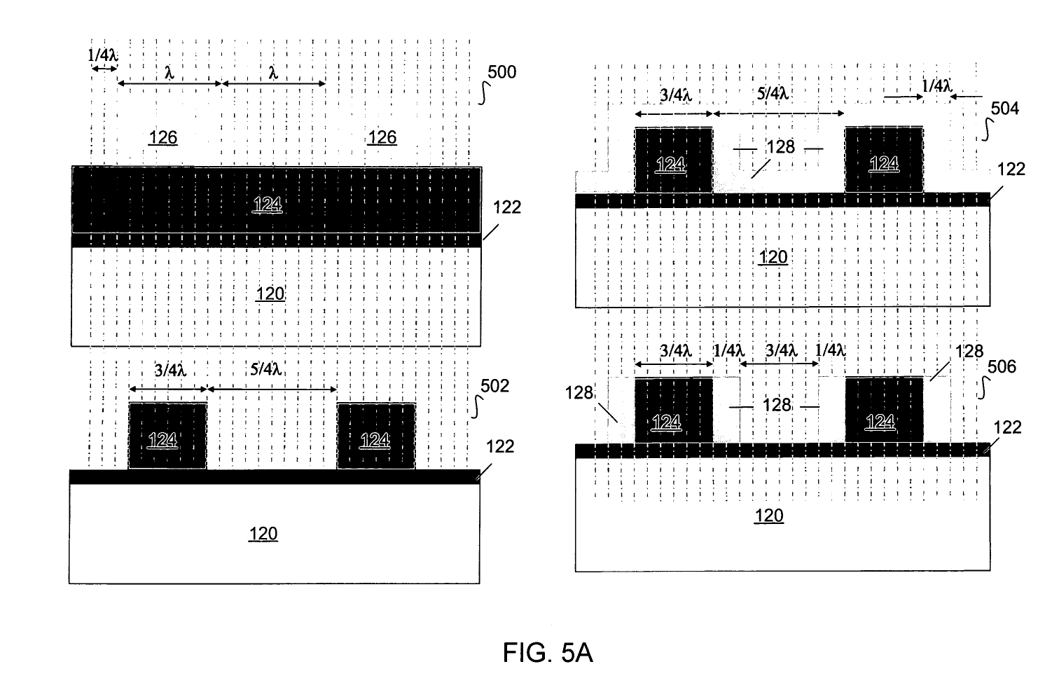

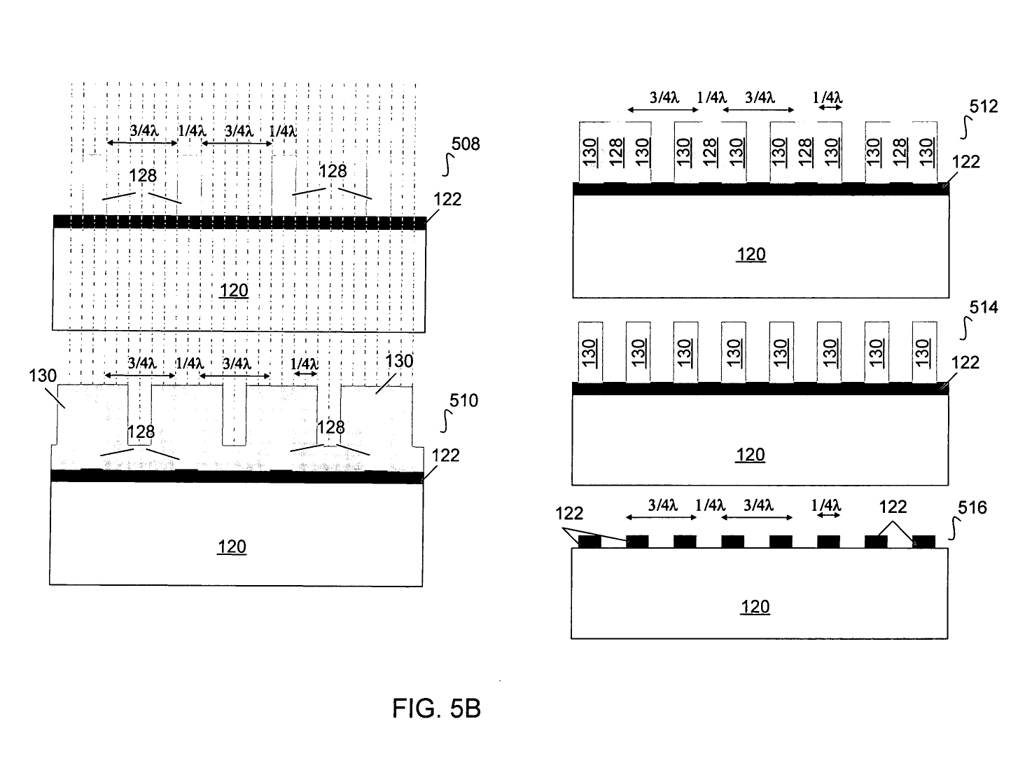

In one embodiment, a quarter-pitch pattern may be fabricated, as defined in FIG. 4. Structure 20 may include a equal geometry between line 22 and space 24 structure (e.g., an approximate 1:1 ratio) at quarter pitch geometries. Referring to FIGS. 5A and 5B, a method for fabricating structure 20 is shown. Similar to step 200, step 500 includes the deposition of first material 122 on substrate 120. Next, second material 124 may be deposited on first material 122, followed by the deposition of photoresist layer 126 on second material 124. Photoresist layer 126 may subsequently etched. In one embodiment, the etching of photoresist layer 126 may result in a substantially equal line to space ratio. In step 502, due to control of the critical dimensions of the photoresist layer and a trim etch process, second material 124 may be etched resulting in a 0.75 λ line and 5/4 λ space pattern.

TABLE 3
Examples of materials used in the fabrication for a 0.25 Lambda patterns
0.25 LAMBDA INTEGRATION

| Case/Layer | 122 | 124 | 128 | 130 | 132 | 134 |
|---|---|---|---|---|---|---|
| A | Si | SiO2 | SiN | SiO2 | SiO2 | SiO2 |
| B | Si | SiN | SiO2 | SiN | SiN | SiN |
| C | SiO2 | Si | SiN | Si | Si | Si |
| D | SiO2 | SiN | Si | SiN | SiN | SiN |
| E | SiN | SiO2 | Si | SiO2 | SiO2 | SiO2 |
| F | SiN | Si | SiO2 | Si | Si | Si |

In step 504, third material 128 may be conformally deposited over the top of the resulting line and space structure of step 502. In one embodiment, the thickness of third material 128 around second material 124 may be controlled to be 0.25 λ. In one embodiment, third material 128 can be deposited using low pressure chemical vapor deposition (LPCVP), plasma enhanced chemical vapor deposition, or atomic layer deposition (ALD). These techniques are suited for conformal depositions and can be designed by anyone skilled in the art

Next, third material 128 may be etched to expose a top surface of second material 124, as shown in step 506. The results from the etching process may include 0.25 λ third material 128 surrounding 0.75 λ second material. A space may also be open, having dimensions of 0.75 λ.

Using an etchant selective to third material 128 and first material 122, second material 124 may be removed, as seen in step 508. The result of step 508 includes 0.25 λ lines and 0.75 λ spaces. A fourth material 130, having a thickness of ¼ λ on each lateral side of third material 128 may be deposited (step 510), and may subsequently be etched exposing a top surface of third material 128, as seen in step 512

In step 514, an etchant selective to fourth material 130 and first material 122, may be used to remove third material 128. Using fourth material 130 as a 1-to-1 mask having one-quarter of the original pitch, the pattern may be transferred to first material 122, as seen step 516. In one embodiment, first material 122 may be etched to form a 1-to-1, 0.25 λ line to 0.25 λ space ratio. Step 516 may also remove fourth material 130, using techniques known in the art. The resultant structure from step 512 is similar to structure 20 of FIG. 4.

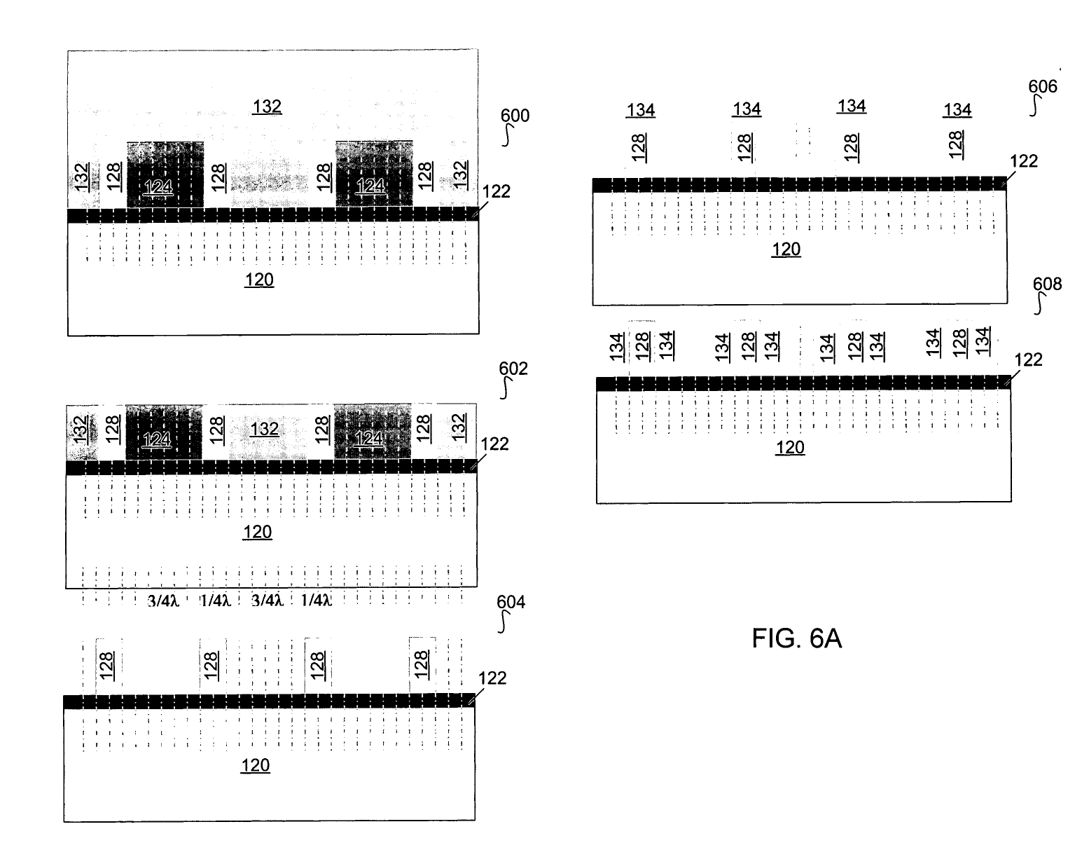

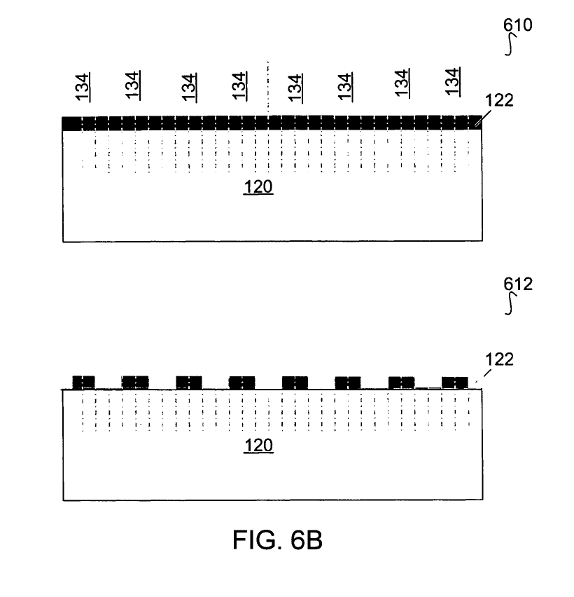

In alternative embodiments, a method for creating substantially equal geometry line to space structure (e.g., the line to space structure having a one to one ratio) at quarter pitch geometry may include using a chemical mechanical polish (CMP) technique, as shown in FIGS. 6A and 6B. In one embodiment, steps similar to steps 500, 502, 504, and 506 of FIG. 5A may be performed. Next, fifth material 132 may be deposited, as seen in step 600. In one embodiment, fifth material 132 may be same material as second material 124. Using a CMP technique, a portion of fifth material 132 may be removed a top surface of third material 128, as seen in step 602. The resultant structure includes, if fifth material 132 is the same material as 124, a repeating array of third material 128 and/or fifth material 132 and second material 124 with having dimensions 0.75 λ and 0.25 λ, respectively.

In step 604, third material 128 and/or fifth material 132 may be removed, using techniques known in the art. The resultant structure now includes second material 124 and spacers having a dimensions of 0.25 λ and 0.75 λ, respectively. Next, sixth material 134 may be conformally deposited over the resultant structure of step 604, where the thickness of sixth material 134 may be about 0.25 λ, as seen in step 606.

Next, in step 608, sixth material 134 may be removed. In one embodiment, sixth material 608 may be etched exposing a top surface of third material 128 and a top surface of first material 122. The exposed top surface of third material 128 allows for the removal of third material 128, as seen in step 610. In one embodiment, third material 128 may be chemically removed using etchant selective to sixth material 134 and first material 122.

Using sixth material 134 as an approximate 1:1 line to space mask having one quarter of the original pitch, the pattern may be transferred onto first material 122. In one embodiment, first material 122 may be etched using techniques known in the art, as seen in step 612. The resultant structure from step 612 is similar to structure 20 of FIG. 4.

Small Trench Structures with Spacers Formation

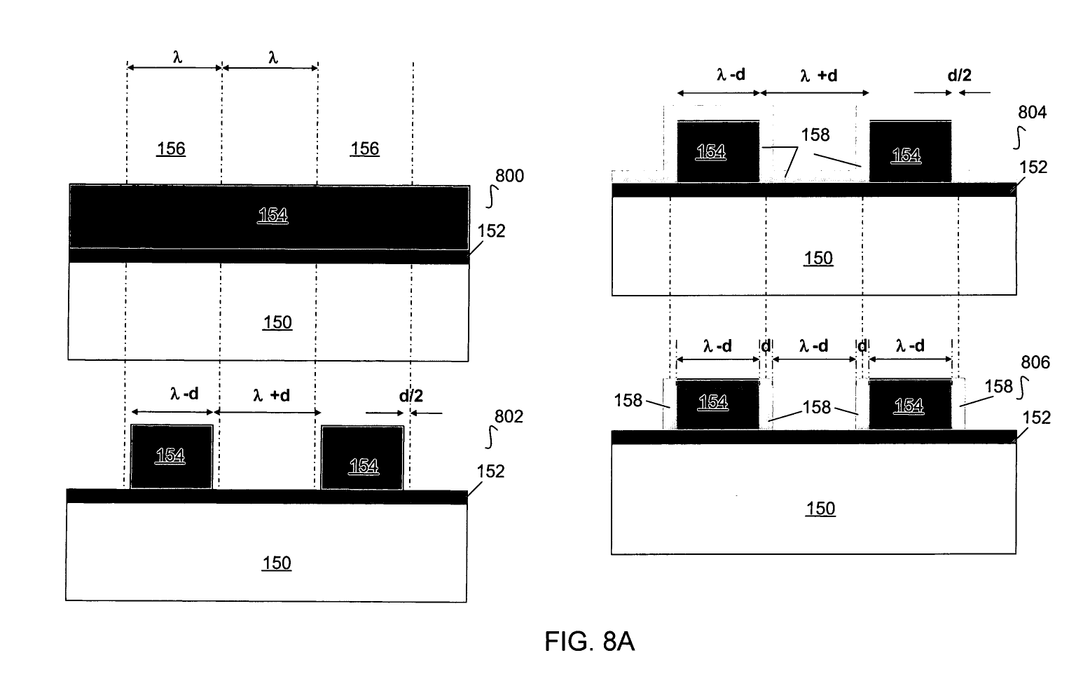

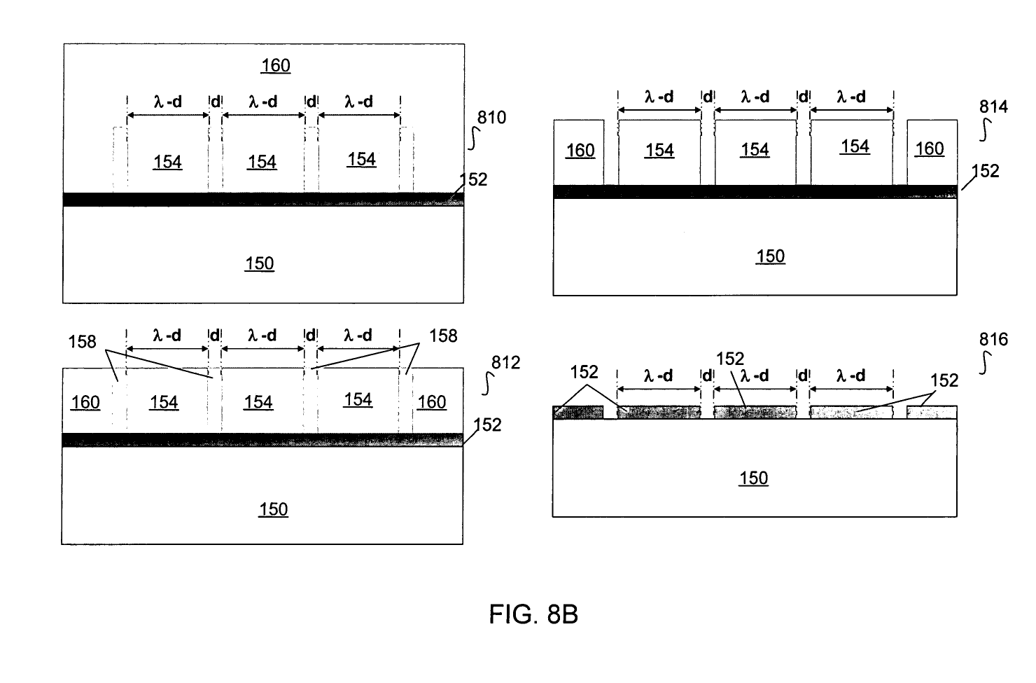

In one embodiment, a small trench structure, such as structure 30 having a plurality of spacers 34 may be formed using methods of the present disclosure, as shown in FIG. 7. Spacers 34 may have a dimension of d and the original pitch of structure 30 may have a minimum pitch of 2 λ, where the pitch may be assumed to be near the resolution limit of the lithography tool used in a pattern transfer. Referring to FIGS. 8A and 8B, a method for fabricating structure 30 is shown.

In step 800, a deposition of first material 152 on substrate 150 may be performed Next, second material 154 may be deposited on first material 152, followed by the deposition of photoresist layer 156 on second material 154. Photoresist layer 156 may subsequently pattern. In one embodiment, the etching of photoresist layer 156 may result in a equal line to space ratio (e.g., the dimension of the line and space is λ).

In step 802, by controlling the critical dimension of the photoresist layer and using at trim etch process, second material 154 may be etched, resulting in the dimensions of λ−d for the line and λ+d for the space. The procedures for controlling the critical dimension of an etched feature are commonly employed in the industry and understood by ordinarily skilled in the art. Photoresist layer 156 may subsequently be removed.

Next, in step 804, third material 158 may be conformally deposited onto the resultant structure of step 802. In one embodiment, the thickness of third material 158 may be approximately d units. In step 806, third material 158 may be removed, exposing a top portion of second material 154. The structure resulting from step 806 includes individual regions of second material 154 with a dimension of λ−d, third material 158 with a dimension of d, and spaces having a dimension of λ−d.

Next, fourth material 160 may be deposited on to the structure resulting from step 806, as seen in step 810. In one embodiment, fourth material 160 may be the same material as second material 154. Using a CMP technique, fourth material 160 may be removed and a top portion of third material 158 may be exposed, as seen in step 812. If fourth material 160 is the same material as second material 154, the resultant structure includes a repeating array of second material 154/fourth material 160 and third material 158 with dimensions of d and λ−d, respectively.

In step 814, third material 158 may be removed. In one embodiment, third material 158 may be etch using an etchant selective to first material 152, second material 154, and fourth material 160. Using second material 154 and/or fourth material 160 as a mask having small trenches with a dimension of d, first material 152 may be etched using conventional techniques known in the art, as seen in step 906. The resultant structure from step 816 is similar to structure 30 of FIG. 7.

It is noted that various combinations of materials may be used to in the method shown in FIG. 8 to form a small trench structure. A non-limiting list of materials is shown in Table 4.

TABLE 4
Examples of materials used in the fabrication for a trench structure
SMALL TRENCH FORMATION

| Case/Layer | 152 | 154 | 156 | 158 | 160 |
|---|---|---|---|---|---|
| A | Si | SiO2 | Resist | SiN | SiO2 |
| B | Si | SiN | Resist | SiO2 | SiN |
| C | SiO2 | Si | Resist | SiN | Si |
| D | SiO2 | SiN | Resist | Si | SiN |
| E | SiN | Si02 | Resist | Si | Si02 |
| F | SiN | Si | Resist | Si02 | Si |

All of the methods disclosed and claimed can be made and executed without undue experimentation in light of the present disclosure. While the methods of this invention have been described in terms of embodiments, it will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope, and concept of the disclosure as defined by the appended claims.

1. A method, comprising:
providing a substrate;
depositing a first material on the substrate;
depositing a second material on the first material;
depositing a photoresist layer on the second material;
patterning the photoresist layer using an electromagnetic radiation source having a wavelength λ;
etching the second material to form a plurality of structures having dimensions less than λ;
depositing a third material on the etched second material;
etching the third material to expose at least a portion of the second material;
removing the second material; and
etching the first material to form a structure comprising a line and a space of substantially equal dimensions.

2. The method of claim 1, further comprising, prior to the step of removing the second material, depositing a fourth material over the third material and the exposed second material.

3. The method of claim 2, the fourth material comprising the same material as the second material.

4. The method of claim 2, further comprising, after the step of depositing the fourth material, using a chemical mechanical polish to remove a portion of the second, third, and fourth materials.

5. The method of claim 4, further comprising, after the step of using the chemical mechanical polish, removing the fourth material.

6. The method of claim 1, the step of etching the first material comprising using the third material as a mask.

7. The method of claim 6, the line and space having a dimension of about λ/2.

8. The method of claim 1, further comprising, after the step of removing the second material, depositing a fourth material over the third material and the first material.

9. The method of claim 8, further comprising, etching the fourth material to expose a portion of the third material.

10. The method of claim 9, further comprising removing the third material.

11. The method of claim 10, the step of etching the first material comprising using the fourth material as a mask for etching the first material.

12. The method of claim 11, the line and space having a dimension of about λ/4.

13. A method comprising:
providing a substrate;
depositing a first material on the substrate;
depositing a second material on the first material;
depositing a photoresist layer on the second material;
patterning the photoresist layer using a light source having a wavelength of λ;
etching the second material to form a plurality of structures having dimensions less than λ;
depositing a third material on the etched second material;
etching the third material to expose a portion of the second material;
depositing a forth material on the etched second and third materials;
using a chemical mechanical polish to expose a portion of the second, third, and forth materials; and
etching the first material to form a structure comprising spaces having a dimension d, where d is less than λ.

14. The method of claim 13, further comprising removing the second and fourth material prior the step of etching the first material.

15. The method of claim 14, further comprising using the third material as a mask for the step of etching the first material, where d is approximately λ/2.

16. The method of claim 14, further comprising, after the step of removing the second and fourth material, depositing a fifth material on the first and third material.

17. The method of claim 16, further comprising etching the fifth material to expose a portion of the third material.

18. The method of claim 16, further comprising removing the third material.

19. The method of claim 18, further comprising using the fifth material as a mask for the step of etching the first material, where d is approximately λ/4.

20. The method of claim 13, further comprising removing the third material.

21. The method of claim 20, further comprising using the second and fourth materials as a mask for the step of etching the first material to form a trench structure.
